(19) United States
(12) Patent Application Publication
(10) Pub. No.: US 2024/0392919 A1
(43) Pub. Date: Nov. 28, 2024

(54) ELECTRONIC SHELF LABEL PROTECTOR FOR RETAIL SHELVES USING DIVIDERS

(71) Applicant: Carl Pomerantz, Beaconsfield (CA)

(72) Inventor: Carl Pomerantz, Beaconsfield (CA)

(21) Appl. No.: 18/794,512

(22) Filed: Aug. 5, 2024

Related U.S. Application Data
(63) Continuation-in-part of application No. 17/942,569, filed on Sep. 12, 2022, now abandoned.
(60) Provisional application No. 63/361,883, filed on Jan. 27, 2022.

(51) Int. Cl. F16P 1/02; G09F 3/20

(52) U.S. Cl. CPC F16P 1/02; G09F 3/208

(57) ABSTRACT

The present invention describes a protector for a single or a plurality of electronic shelf labels (“ESL”) to protect the ESL from impact disturbance, displacement, or dislodgement by a shopping cart, restocking cart, a person, or other causes, while offering full and comprehensive installation or relocation of shelf dividers. The protector has a mounting portion, a bend portion, and a shielding portion. The protector is made of a rigid, clear material, and its mounting portion mechanically attaches to the forwardmost region of the top surface of a display shelf. The protector has predrilled holes to align with a shelf's holes to facilitate full and comprehensive installation or relocation of shelf dividers without the need to drill additional holes. The protector's shielding portion has rounded or chamfered corners for safety to prevent snagging on clothing, carts, or other elements that may brush up against the protector.

This Continuation-In-Part Utility patent application claims the priority to and the benefit of US Non-Provisional utility patent application Ser. No. 17/942,569, filed on Sep. 12, 2022, entitled SHELF EDGE PROTECTOR FOR ELECTRONIC SHELF LABELS, which claims priority to and the benefit of U.S. Provisional Patent Application Ser. No. 63/361,883, filed Jan. 27, 2022, entitled Improved Shelf Edge Protector for Electronic Shelf Labels, whereby the contents of both referenced priority applications are incorporated herein.

The disclosed invention protects either a single electronic shelf label (“ESL”), or a plurality of ESLs, from damage and dislodging by customers and staff. It is easily installed onto any standard shelf edge with holes, and, due to the invention's novel features, the invention now allows for completely unhindered shelf divider installation and shelf divider relocation. Use of shelf dividers is imperative for some retailers to prevent commingling of inventory, and the present invention does not hinder placement of shelf dividers anywhere the retailer wishes to install them. In other words, this invention's strongest feature is permitting fully comprehensive installation or relocation of shelf dividers anywhere on the shelf while offering protection for a single or a plurality of ESLs.

Some retail stores use a specific system of shelf dividers to prevent commingling of inventory on retail shelves. In one embodiment of a standard shelf divider, the distal ends of these dividers comprise prongs that are inserted into pre-drilled holes on retail shelves. Other embodiments of standard shelf dividers can be attached to a shelf using nuts and bolts, plastic rivets or, or self-engaging tabs.

Inventory gets routinely reorganized and rearranged on retail shelves depending on seasonal promotions, and the present invention permits shelf dividers to be placed anywhere on the shelf while simultaneously protecting ESLs from disturbance. A typical store that uses this system of shelf dividers can have up to 20,000 shelf dividers in use at any given point in time. The present invention protects either a single or a plurality of ESLs while permitting full and comprehensive installation or relocation of shelf dividers anywhere the retailer wishes to install them.

### BACKGROUND

In retail, items need to be priced so that shoppers/clients can be made aware of an item's price prior to purchase. Up until the latter part of the twentieth century, most retailers ticketed individual products with pricing by gluing a label on each individual item. This was a clear way for customers to know pricing, but was very labor intensive for store personnel to do. It was also very complex to logistically control price changes.

Towards the end of the 20^{th} century, new merchandising methods were developed so that ticketing individual items with price tags was replaced by placing a label or sticker on the shelf edge or merchandizing peg so that all products behind or above the price ticket (commonly known as a bin ticket) had a ticketed price. This “single price label per group” change represented a major labor savings to the retailer.

With advancements in technology at the end of the 20^{th} century, it has become possible to replace these formerly paper, cardstock, or stickered price labels, with Electronic Shelf Labels (commonly referred to as ESLs).

ESL systems provide significant operational labor savings to the retailer. With traditional paper bin tickets, every time a price change occurs, there is data entry to register the price change, plus new bin tickets have to be printed, sorted, old tickets removed, and new tickets manually inserted. Labor time involved, on average, is estimated at several minutes per label price change.

With ESLs, price changes can be wirelessly conducted, automatically and electronically updated, and changed. Furthermore, the ESL labels themselves can also display additional data beyond price, such as inventory information. Accuracy of information is improved. Within seconds, prices on the ESLs can be electronically updated across multiple systems, so pricing can quickly be changed to stay competitive and match the competition.

This yields improved retailer productivity, pricing accuracy, and price agility for the retailer. A further benefit and goal is improved promotional opportunities, and better communication of pricing information to shoppers.

When a retailer decides to convert the store's pricing system from paper labels to ESLs, they can retrofit a standard extruded plastic strip with a channel onto the standard retail shelf edge. The front face of the plastic strip's channel features a pair of engaging lips to accommodate the ESL's engaging tabs. With this assembly, the ESL can be attached and now display pricing information about items behind the ESL.

The ESL's engaging tabs can be snapped into the channel to display a price for an item on the shelf edge. While it is important that the ESL engages firmly into the channel, not all ESLs are manufactured within strict tolerances of the channel. Thus, if the fit between the ESL and channel is too loose, the ESL can be dislodged from the plastic strip with an accidental bump from a shopping cart or by snagging on a customer's garment. This is problematic, as the ESL is then no longer indicating the correct price and other info, in front of the proper product.

The ESL is comprised of an assembly that includes a battery, a display face, and sophisticated, miniaturized internal electronics. All of this is housed in a relatively, somewhat fragile, plastic molded housing.

In the course of normal activity in a store, the ESLs in place on a shelf edge can be subject to significant physical disturbance by shoppers and store personnel.

One form of disturbance is via direct impact, for example from a shopping cart, or a store associate's stock-fulfilling cart, lift truck, or jigger used while moving skidded merchandise. Other examples of disturbances include ESLs accidentally being hit by shoppers or store personnel, when people place or remove merchandise, or simply by people accidentally bumping into the ESLs when walking too close by the ESLs. As well, ESL disturbance occurs by the cleaning personnel while using floor cleaning, mopping, sweeping and buffing equipment. Also, when the ESL assemblies are easy to displace, customers can be inclined to simply slide or displace the ESL as a form of absent mindedly fidgeting.

In some cases, a direct heavy impact can immediately break the ESL. A more lateral collision can lead to lateral displacement of the ESL, either from the strip, or the ESL and strip assembly can be together laterally displaced. In other instances, a lateral hit can result in the ESL detaching from the strip and the ESL falling to the floor, or into the shelf. The strip remains empty in place, while the ESL might break on impact on the floor, be run over with a shopping cart wheel, stepped on and broken, or simply lost or misplaced.

In other instances, the ESL remains attached to the channel, but both are simultaneously dislodged off the shelf edge, fall and break, or are lost. In other instances, both are dislodged and separated.

In all of the above (and other examples of ESL disturbance), displacement, dislodgement, and breakages, the central and most critically important function of the ESL, which is to accurately display the pricing in front of the appropriate group of articles, is rendered completely ineffective. A displaced or broken ESL therefore creates costly operational chaos for the retailer and their shoppers.

Periodically, for example during seasonal changes, a store must empty and completely rearrange stock on its shelves. The retail plan for exactly where products will be placed is commonly known as a ‘planogram’. Very typically in chain stores, the planogram has been mapped out at head office, so that a store's retail shelf space can be fully optimized by following the planogram.

Each SKU (Stock Keeping Unit) on a shelf has at least one ‘facing’. A facing is defined as the first, and forwardmost product, in a given row of the same product SKU. A facing is the product directly visible and accessible to the customer in a given row.

When a store associate must redo a planogram on a given shelf, they will typically follow the following steps, to make sure their shelf product arrangement exactly conforms to the planogram layout.

For a given empty shelf to be loaded, the associate would typically fill a wagon with all the product SKUs for the given empty shelf. They would also gather loose shelf dividers and ESLs to be placed on the shelf edge.

With the planogram layout plan in hand, the associate would start at one end of the shelf, place a divider, place one or more facings of the same SKU in the forefront of the shelf, and then place another divider, before repeating onwards with the next adjacent SKU.

A standard retail shelf has several rows of holes that can accommodate shelf dividers. These rows run parallel to the shelf's length so that a store can place dividers at their discretion.

In one common shelf divider embodiment, the divider has two prongs in its rear portion. Prongs are inserted into the rear shelf holes, and the associate displaces the divider rearwardly so that these rear prongs fully engage into the shelf's holes. The associate then forces the divider's front single prong into the corresponding front shelf hole, so that the divider is now firmly stable and fully engaged. However, there are other ways to attach a shelf divider to a shelf, such as using nuts and bolts, plastic darts or rivets, or self-contained engaging tabs.

The associate continues this divider/SKU facing/divider/SKU facing placement process, across the entire shelf length. In order to optimize a store's selling space utilization, these planograms are typically very tight. As a result, it is not uncommon during this planogram fulfillment process for the associate to proceed across the shelf with facings and dividers, and get to the end of the shelf, only to discover that all facings do not quite fit. The associate must then go back, and slightly shift all product and dividers to readjust, so that all facings ultimately fit per the planogram layout.

Once this is complete, and all facings and dividers are in place, the associate then takes their ESLs, and positions each ESL in the front, center of each section of facings for each given SKU. Typically, the ESL is mounted onto a track installed onto the shelf's front edge. For clarity to the customer, the ESL needs to be positioned in the center, between a given SKU's two dividers.

Periodically, one SKU may have multiple facings, between its dividers at each extremity. Prior to the advent of ESLs, paper shelf edge labels were used, and typically each of these multiple facings within a given SKU, were each given their own shelf label. This way, there was built in redundancy for price indication within a given SKU; if one of the SKU's paper labels was displaced, pricing for the SKU would still be indicated by one of the other redundant shelf edge labels.

However, an ESL's cost is approximately 90 times the cost of a paper label. Therefore, in a shelf zone that contains multiple facings for the same SKU, the retailer, to save ESL costs, will typically now aim to avoid this labelling redundancy, and will place only one single ESL in the center of the multiple SKU facings. As a result, any dislocation or damage to the SKU's single ESL, creates an immediate problematic operational issue. With paper shelf edge labels, there was a safety net of sorts, by way of redundancy/multiple labelling within multiple facings of a given SKU. With ESLs, there is no such safety net. It is therefore essential that the ESL is always centered, and fully functional.

Once these steps are completed, the associate then fills and stocks the entire depth of shelf with product. If an ESL protector is not installed at the outset prior to stocking the shelf, unfortunately, in time, the store may discover that this loaded shelf is experiencing ESL damage or displacement from aisle traffic, i.e. shopping carts, restocking carts, and customers' garments. Sometimes this problem is foreseeable in advance. However, more commonly, the problem presents itself only after all of the planogram is in place for a few days, or a few weeks. ESL damage/displacement is then an urgent problem, as product pricing is no longer clearly indicated to customers, so this must be rectified quickly. To add to the urgency, the retailer's rationale for having initially invested in costly ESLs (versus traditional paper labels), was to save and cut labor costs. As a result, the retailer with ESLs now has a more limited personnel pool to address, and rectify, this urgent ESL breakage/displacement crisis.

Existing prior art ESL protectors either have (a) no way to attach the protector to the shelf, (b) an adhesive strip to glue the protector to the shelf edge, or (c) 3 to 5 pre-drilled holes, so that a retailer can pass either a rivet or a prong of a shelf divider through the holes and into the holes on the retail shelf.

There is known US20080282592 to Brinkman for “Roll Formed Channel for Electronic Price Label Units”, wherein FIG. 15 of this prior art discloses a mounting portion with pre-drilled holes offering access to the retail shelf's holes.

The present invention is essentially a combination of abovementioned prior art (c) and Brinkman's FIG. 15. However, this combination has resulted in extraordinary advantages that were initially unforeseen by the end users, namely that this invention protects a single or multiple ESLs while allowing fully comprehensive installation or relocation of shelf dividers anywhere on the shelf. Such advantages are characterized by tremendous savings of time for installation, avoiding unnecessary retail aisle closures, not putting store personnel at physical risk, and eliminating the need to hire specialized workers to drill holes.

To protect ESLs from disturbance using the above-mentioned prior art (a), (b), or (c) protectors, fully comprehensive installation or relocation of shelf dividers was terribly cumbersome and slow. Drilling holes is usually required so that the meticulously placed dividers could be put back in exactly the same position to align with shelf holes. The retailer would have to find and assign an associate with enough skill level and certified safety level to implement the following steps: (1) close off the store aisle or section in the vicinity of the problematic shelf (for safety), (2) arrive with a power drill, safety glasses, vacuum cleaner, marker, attachment fasteners, and a prior art protector, (3) remove all facings, plus product, at least several products deep (else they will get covered in drilling debris), (4) pop out front prongs of dividers, (5) slide in prior art protector and attach with fasteners, (6) with a marker, indicate the spots where the front of each divider must penetrate the protector, so that the dividers' front prong can then engage the shelf's hole, (7) drill necessary holes, (8) reinsert front divider prongs through the protector's drilled holes, into the shelf holes, (9) rework/redrill any holes that may fail to exactly align, (10) vacuum the surrounding area of plastic chips and debris generated by the drilling, (11) restock all items, in their appropriate position, across the full length and depth of the shelf, and (12) re-open sealed off area in the vicinity of the shelf. If, for example, a store associate discovers that a shelf divider must be placed in a different location, steps (6) to (12) must be repeated over and over again until the correct result is achieved.

In contrast to the above 12-step fully comprehensive installation or relocation of shelf dividers using prior art (a), (b), or (c), fully comprehensive installation or relocation of shelf dividers using the present invention can be accomplished by any associate without drilling skills or experience. The steps comprise: (1) detaching front prongs of shelf dividers out of shelf's holes (if dividers installed), (2) placement of protector onto shelf, so that it aligns with shelf's holes (3) mechanically attaching protector to shelf, and (4) assuring a fully comprehensive installation or relocation of shelf dividers to separate inventory from commingling. The present invention is the only ESL protector that offers step (4) because a substantial number of holes in the shelf are accessible through the holes in the present invention. No other ESL protector offers this feature. No drilling of additional holes is necessary because the invention is essentially invisible from the perspective of a retail shelf's holes.

In field trials and testing in stores that use shelf dividers, users discovered that the availability of all or most of the holes in the protector for placement of dividers is not only a useful feature, it is an absolutely essential feature for fully comprehensive installation or relocation of shelf dividers.

Due to the fact that no additional holes need to be drilled in the mounting portion of the present invention, installation time is significantly reduced if compared to prior art. Also, and even more significantly, zero skill, and zero safety certification are required by store associates, and the store area does not need to be sealed off for safety reasons, nor vacuumed. A completely non-skilled associate can now quickly, easily, and safely rectify an ESL breakage/displacement problem area. With prior art, fully comprehensive installation or relocation of shelf dividers was far more onerous, complicated, skill-heavy, and slow.

Until the advent of the present invention, no ESL protector offered pre-drilled holes to permit access to a substantial number of shelf holes so that shelf dividers can be fully and comprehensively installed. One of the present invention's test users, a manager of a large retail store, reported that once prior art manufacturers examined the present invention as used to protect ESLs on the test store's shelves, they began copying and offering the identical feature, namely a substantial number of pre-drilled holes, to permit full and comprehensive installation or relocation of dividers anywhere on the retail shelf.

As mentioned earlier, there is also a known prior art ESL protector with 3 to 5 predrilled holes for attachment. This is the most relevant prior art to the present invention, as it has taken into account pre-drilled holes to easily attach and remove the ESL protector. However, although these predrilled holes do facilitate attachment of the protector to shelves, they are flawed because they neither recognize, nor allow for access, to other holes for shelf divider placement, and they do not facilitate fully comprehensive installation or relocation of shelf dividers.

Also, because of product placement on shelves, in some cases having only five holes in predetermined locations is not desirable, as the retailer is now forced to only use specific holes for attachment that perhaps are not ideally located/accessible for some shelf product layout situations. In extreme high-activity exposure zones, sometimes more than five attachment points are desirable for improved impact resistance.

For example, in one embodiment of the present invention, the ESL protector is 48″ long with a hole every 0.5″, totaling 94 holes, thus offering unimpeded shelf divider access along the entire length of the ESL protector without the need to drill additional holes.

As a result of the mounting portion being affixed to the shelf top, and the invention's mounting portion, shielding portion, and bend portion, each being of significant thickness and rigidity, the horizontal impact forces on the shielding portion, are transferred to the shelf top, and are absorbed by the shelf, via propagation of impact stresses within and across the invention.

There is known US20040050812 to Rojas for a “Label and/or Sign Holder”. This invention discloses a retrofitting label holder. This invention is designed to be used on a retail shelf that has holes. The invention has a thin upper mounting portion and a channel into which paper labels can be installed. This invention's mounting portion, being a thin-like film, is immobilized on a shelf by piercing a push pin through its mounting portion and subsequently through a hole in the shelf. The film-like element is a bit thicker than a sheet of paper, being “perhaps 0.005 inch” thick. Rojas's mounting portion therefore lacks rigidity. If a cart hits the ESL protector of the present invention, the present invention pushes back without transferring the force to the ESL because the present invention is one rigid piece. Rojas cannot push back because its mounting portion lacks rigidity. Just as the physics principle that you cannot push on a rope, this rigidity characteristic is missing from the upper portion of Rojas. If Rojas's mounting portion were combined with the present invention's rigid shielding portion and bend portion, the resultant protector would be ineffective and useless due to the lack of rigidity of Rojas's mounting portion.

There is also known US20080282592 to Brinkman for “Roll Formed Channel for Electronic Price Label Units” disclosing a retrofitting ESL label holder for a retail shelf. Brinkman's FIG. 15 discloses an identical row of mounting holes in its mounting portion, which is an important part of the present invention's new combination. Other than also providing shelf hole access, Brinkman, from the bend downwards, does a very different function from the present invention: it offers no protection for ESLs from impact or disturbance, and to the contrary, suspends ESLs even further into the shopping aisle's lane of travel, increasing chances of impact or disturbance. There is also known U.S. Pat. No. 10,588,430 to McKeel for “Clip for Securing Elongated Label Track and Associated Systems and Methods”. This invention is a narrow plastic clip designed to retain flat label tracks for paper labels. McKeel has three anchor points: two that mate with a retail shelf's holes, and one that clips underneath the shelf edge. The fact that McKeel obscures the retail shelf's holes due to its anchoring features, McKeel prevents full and comprehensive installation or relocation of shelf dividers.

The present invention is a combination of existing prior arts' (a), (b), (c) shielding portions and bend portions, combined with Brinkman FIG. 15. Unlike all prior art protectors, this new and inventive combination brings new and synergistic results for the end user due to this invention's ability to offer ESL protection, plus full, unimpeded access, for comprehensive installation or relocation of shelf dividers.

### OBJECT OF THE PRESENT INVENTION

The object of the current invention is to offer protection of a single electronic shelf label (“ESL”), or a plurality of ESLs, and the label strip the ESL(s) is/are attached to, while providing the ability for full and comprehensive installation and relocation of shelf dividers The protection offered is against impact, disturbance, displacement or dislodgement.

The present invention is designed to protect ESLs from disturbance and dislodgement in retail stores that use shelf dividers for preventing inventory from commingling with each other, wherein shelf dividers comprise a various range of divider immobilization means (such as prongs, tabs, or the like) that mate with holes in retail shelves.

The invention comprises a transparent plastic protector in two parts: a horizontal mounting portion that is attached to the forwardmost region of a retail shelf, and an angled shielding portion that covers either a single ESL or a plurality of ESLs. The mounting and shielding portions are connected by a rigid bend portion. In one embodiment of the present invention, a lengthwise hinge is located between the bend portion and the mounting portion's holes.

The invention is attached to the shelf only by the mounting portion. Therefore, the mounting portion (and the entire protector) has to be made of a material thick enough to be able to withstand and absorb an impact from a shopping cart or restocking cart and not break off.

As it is imperative for a store to be able to fully and comprehensively install shelf dividers (to separate inventory) at any given point on the shelf, the mounting portion must have holes or through-openings that exactly align with holes or through-openings of a standard retail shelf. As far as shelf dividers are concerned, the mounting portion is invisible to them due to its plurality of holes.

The shielding portion of the present invention is suspended over the ESL(s), and serves as a shield for ESL(s) mounted to the edge of a retail shelf.

The invention features holes to match the orientation of holes on the forwardmost region of the top face of the shelf, so that upon installation, some or all shelf holes are left unobstructed and accessible for shelf dividers and the like. All corners of the protector can be rounded or chamfered for safety and to prevent snagging. Not only do rounded corners prevent snagging on a passing person's clothing, rounded corners also facilitate deflection of pallet trucks or restocking wagons, which, if snagged on the ESL protector, may cause the ESL protector to be dislodged or buckle upwards, thus disturbing the SKUs.

The protector of the present invention attaches to the shelf via shelf dividers, rivets, zip ties, or other attachment means, so that the invention is firmly and easily mounted to the shelf edge and can be easily replaced for full and comprehensive installation or relocation of shelf dividers when desired. The forward front face of the protector is inclined downwards and dimensioned to form a shield over the ESL(s), thereby protecting them from impact and disturbance by a shopping cart, restocking cart, or accidental contact by a shopper or employee.

It is notable that the invention's holes must align with a standard retail shelf's holes, typically by ½-inch or 1-inch centers. In this way, shelf holes are left accessible and unobstructed for attachment of shelf dividers or the like.

The invention renders it easily relocatable for full comprehensive installation or relocation of shelf dividers with zero shelf surface defacement upon removal, as well as offering a fully comprehensive installation or relocation of shelf dividers anywhere they need to be installed. The invention can be dimensioned such that embodiments can be attached directly adjacent to one another, with no obstruction of shelf holes, thereby permitting fully comprehensive installation or relocation of shelf dividers.

Another major advantage of this invention over the prior art is that there is no skill required to properly install the invention while still offering a fully comprehensive installation or relocation of shelf dividers. Personnel simply have to align the protector over the holes and install the fasteners or shelf dividers. Even if it is accidentally placed in the wrong transverse shelf position, fasteners can be disengaged, and the invention can be easily detached and relocated as desired, while still offering full, unimpeded installation or relocation of shelf dividers.

When undisturbed and at rest, the mounting portion of the invention is held in place on the shelf surface via the front prongs of dividers, and/or plastic attachment darts or rivets.

When in undisturbed mode, the bend portion has minor flex forces employed, so that the shielding portion is cantilevered, and its shielding, free bottom edge remains firmly suspended in place.

When the protector is hit, for example with a shopping card or stock wagon, the applied impact force is horizontal. The structural protective mechanism of the protector acts to counteract this horizontal impact force, by creating counteracting stresses up and across the shielding portion, traversing the bend portion, and absorbing these impact stresses across the mounting portion, and then transferring these via shear stresses across the shelf attachment means, into the shelf. For this ESL protector to function correctly, it is essential that the bend portion has significant resistance to bending.

However, depending on shelf type, and variation of fixturing detailing from different shelf suppliers, sometimes there can be contact between the upper or lower edge of the ESL's front face, and the inner face of the invention's shielding portion. In this situation, on impact, the ESL's edge will experience some of the impact forces, but the invention would still serve to absorb the bulk of the impact forces.

In some embodiments of prior arts, and of the invention, a flexible hinge can be incorporated along the entire length of the mounting portion, in the zone between the forward most shelf holes, and the bend portion.

This flexible hinge allows for easier access to the ESLs once the invention, or prior arts, are in place.

### BRIEF DESCRIPTION OF THE DRAWINGS

FIG. 1 shows a perspective view of the first embodiment of the present invention, namely a short protector.

FIG. 2 shows a side view of a transition between inoperative and operative mode of a preferred fastener, namely a rivet.

FIG. 3 shows a front view of the first embodiment with an ESL, during installation of fasteners.

FIG. 4 shows a front view of the first embodiment with an ESL, after installation of fasteners.

FIG. 5 shows a perspective view of the second embodiment of the present invention, namely a long protector.

FIG. 6 shows a perspective view of the first embodiment with through-openings being slots instead of round holes.

FIG. 7 shows a perspective view of the first embodiment with through-openings being square holes instead of round holes.

FIG. 8 shows a perspective view of the second embodiment installed onto a shelf by using shelf dividers as fasteners.

FIG. 9 shows a side perspective view of prior art, attached to a shelf with adhesive.

FIG. 10 shows a perspective view of prior art after damage.

FIG. 11 shows a front view of a third embodiment of the present invention.

FIG. 12 shows a perspective view of a variant of the second embodiment with six through-openings.

FIG. 13 shows a perspective view of the second embodiment with chamfered corners.

FIG. 14 shows a perspective view of the first embodiment with chamfered corners.

FIG. 15 shows a perspective view of another variant of the second embodiment with two rows of holes to accommodate another model of a display shelf.

FIG. 16 shows another variant of the second embodiment as seen on FIG. 13 with two rows of holes.

FIG. 17 shows a variant of the first embodiment with through-openings being transverse slots rotated 90 degrees to the slots shown on FIG. 6.

FIG. 18 shows the first embodiment with through-openings being pressure-actuated holes.

FIG. 19 shows the second embodiment with a hinge.

### DETAILED DESCRIPTION OF THE PREFERRED EMBODIMENTS

The present invention is a protector for a single Electronic Shelf Label (“ESL”) or a plurality of ESLs. The protector shields ESLs from impacts that would otherwise dislodge or damage ESLs while offering full and comprehensive installation or relocation of shelf dividers. The protector is easily installed or removed by a store staff member with little or no skill. To ensure adequate rigidity for ESL impact protection, the thickness of the present invention is in the range from 0.030″ to 0.125″.

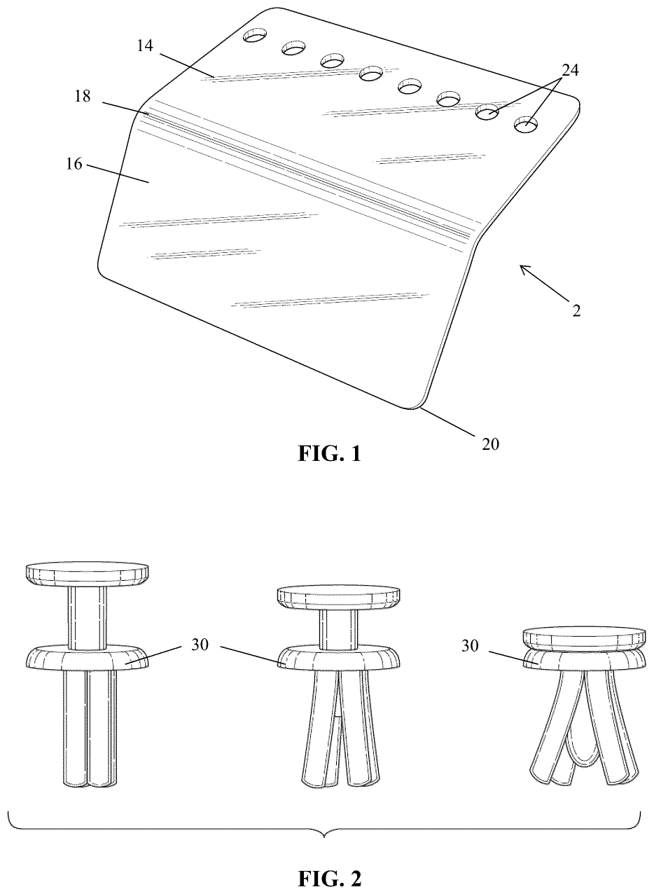

Referring now to drawings, FIG. 1 shows the first preferred embodiment of the present invention, namely a short protector 2 for a single ESL, comprising a substantially horizontal mounting portion 14 with a plurality of through-openings 24, connected to shielding portion 16 via bend 18, said shielding portion 16 being under a predetermined angle with relation to mounting portion 14. Corners 20 of shielding portion 16 are curved to prevent snagging. Protector 2 is slightly wider the width of an ESL. Through-openings 24 are spaced ½ inch apart.

FIG. 2 shows the transition of a preferred fastener 30 between inoperative or pre-installation mode and operative or post-installation mode. Preferred fastener 30, namely a plastic anchor rivet, comprises a body and a pin, said body adapted to expand once pin is inserted.

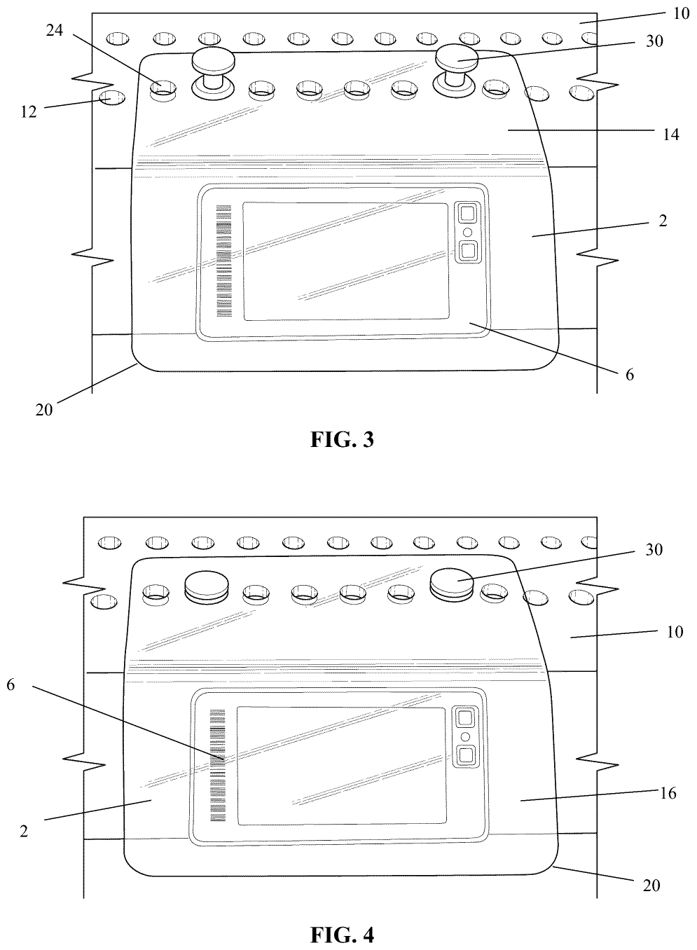

FIG. 3 demonstrates mid-installation process of protector 2 onto forwardmost region of top face of shelf 10, wherein fasteners 30 are inserted into through-openings 24 of mounting portion 14, and subsequently into through-openings 12 located in forwardmost region of top face of shelf 10. Protector 2 is installed to substantially cover ESL 6.

FIG. 4 shows the installed protector 2 over ESL 6, wherein fasteners 30 are fully inserted into forwardmost region of top face of shelf 10's through-openings 12. Protector 2's shielding portion 16 comprises rounded corners 20 for safety and to prevent snagging.

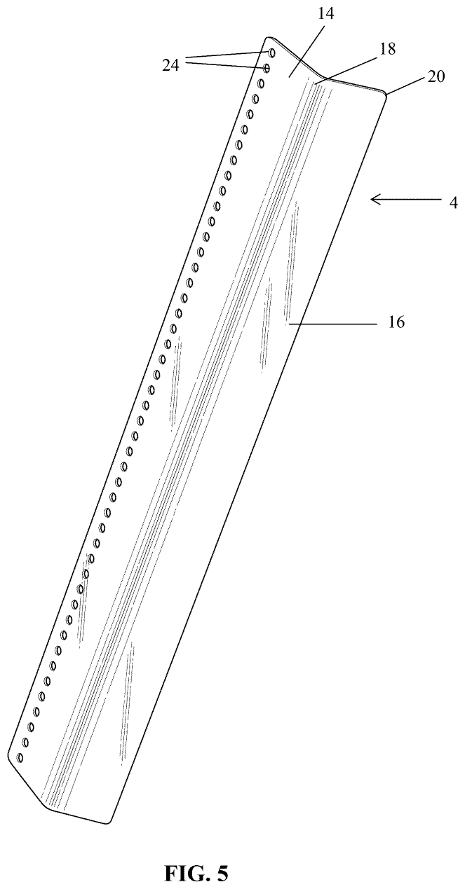

FIG. 5 demonstrates the second preferred embodiment of the present invention, namely a long protector 4, adapted to protect a plurality of ESLs. Protector 4 comprises a substantially horizontal mounting portion 14 connected to shielding portion 16 via bend 18, shielding portion 16 being at a pre-determined angle to mounting portion 14. A plurality of through-openings 24 are located in proximity to the distal edge of mounting portion 14. Corners 20 of shielding portion 16 have a rounded configuration to prevent snagging, and for safety.

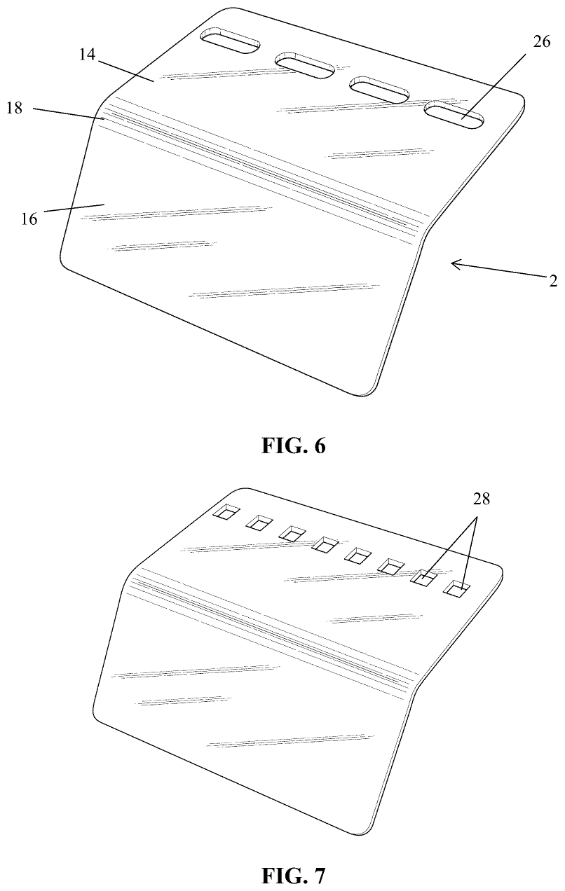

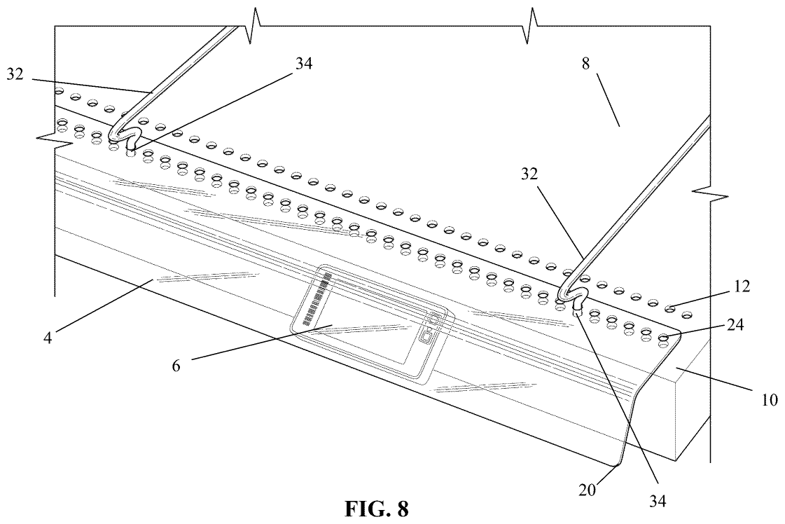

FIG. 6 shows a variant of the first embodiment 2 with through-openings being slots 26 instead of round holes 24. Slots 26 allow for installation on forwardmost regions of top face of shelf 10 with non-standard through-openings 12 configurations. FIG. 7 shows first embodiment 2 with square through-openings 28 instead of round holes 24, to adapt to different models of shelves. It should be noted that through-openings 24 can be of other shapes other than slots 26 or squares 28, such as hexagons, octagons, or the like.

FIG. 8 shows the second embodiment 4 installed on shelf 8's forwardmost region of top face of shelf 10 using shelf dividers 32. A standard shelf divider 32 comprises a prong 34 adapted to be inserted in forwardmost region of top face of shelf 10's through-opening 12 to prevent products from commingling on the same shelf 8. Prong 34 can be used as a fastener to attach protector 2 or 4 to forwardmost region of top face of shelf 10 by first being inserted into through-opening 24 of protector 2 or 4, and subsequently into through-opening 12 located on forwardmost region of top face of shelf 10. Therefore, protector 2 or 4 is immobilized over ESL 6.

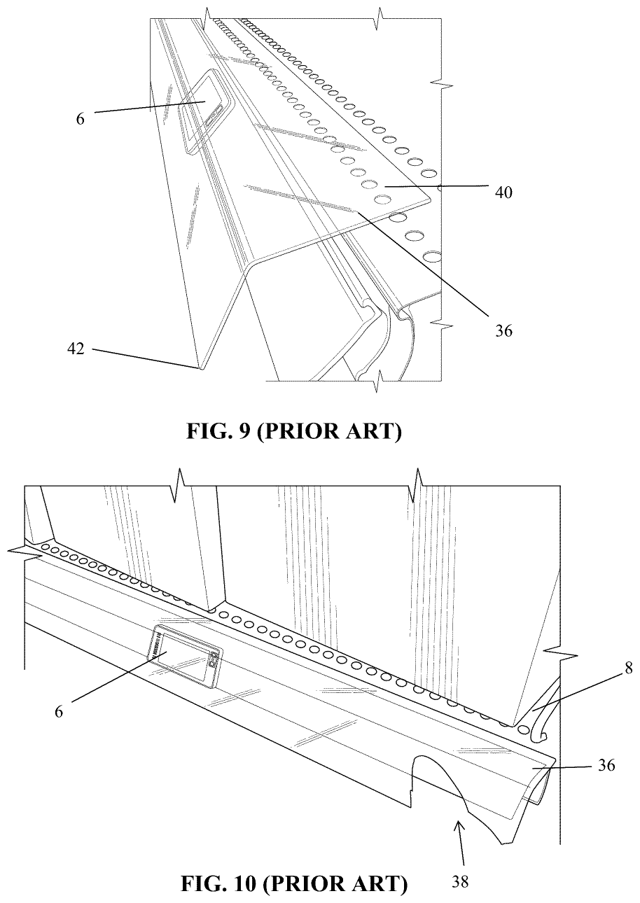

FIGS. 9 and 10 show prior art 36 comprising a protector installed on forwardmost region of top face of shelf 10 using adhesive 40. Prior art 36 obscures through-openings 12 on forwardmost region of top face of shelf 10, prohibiting installation of shelf dividers 32 unless a skilled person manages to drill a corresponding hole in prior art 36, which is a dangerous and complicated procedure. In addition, prior art 36 comprises square corners 42 that are prone to snagging on clothing and store equipment. As seen on FIG. 10, if something snags on corner 42, there is a high probability that prior art 36's corner 42 will fracture or shatter, and cause damage 38, thereby necessitating replacement of the entire protector of prior art 36.

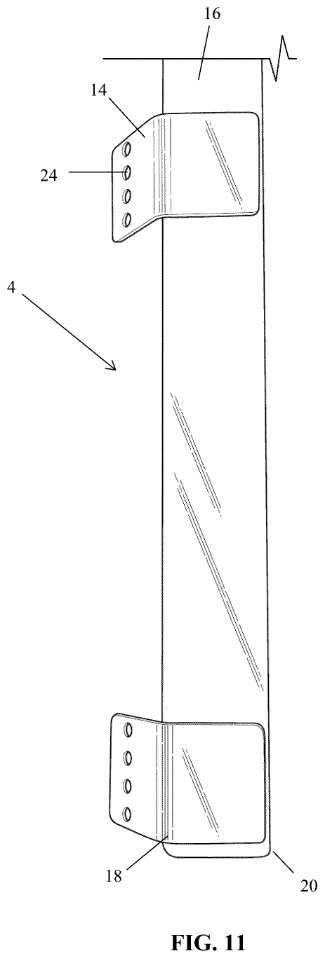

FIG. 11 demonstrates a variant of the second preferred embodiment 4, wherein mounting portion 14 is intermittent with relation to shielding portion 16. Mounting portion 14 only extends where the attachment points are necessary for installation to forwardmost region of top face of shelf 10. This variant reduces the continuous lip created by the distal edge of mounting portion 14 as seen on FIG. 5, thereby not interfering with the ability to slide heavier objects off the shelf by a customer.

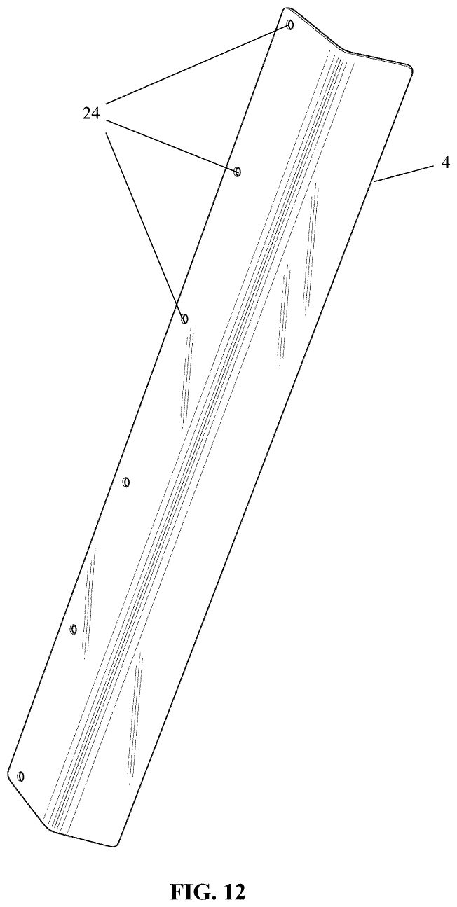

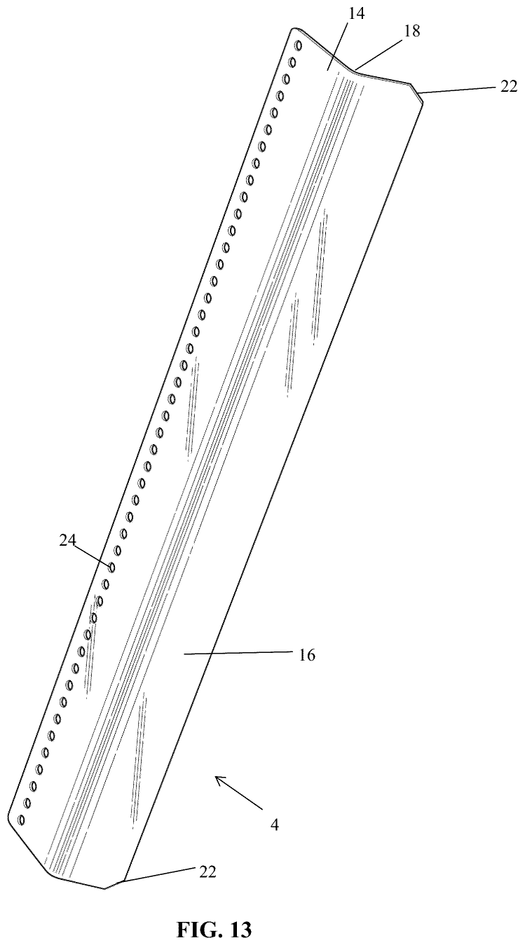

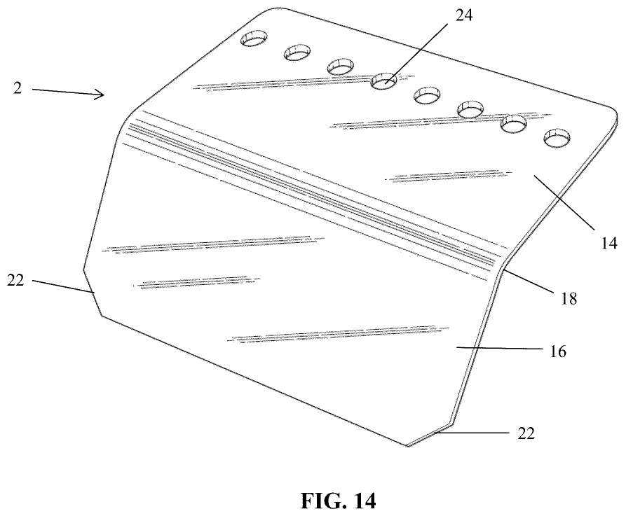

FIG. 12 shows another variant of the second preferred embodiment 4, with six through-openings 24. FIGS. 13 and 14 show first and second embodiments 2 and 4 with chamfered corners 22 instead of rounded or curved corners 20. It should be noted that one or more chamfers 22 are possible on a single corner.

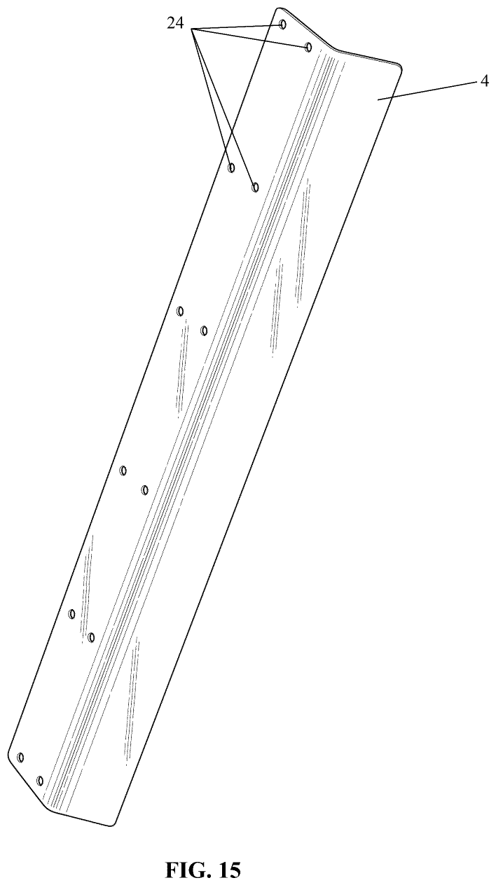

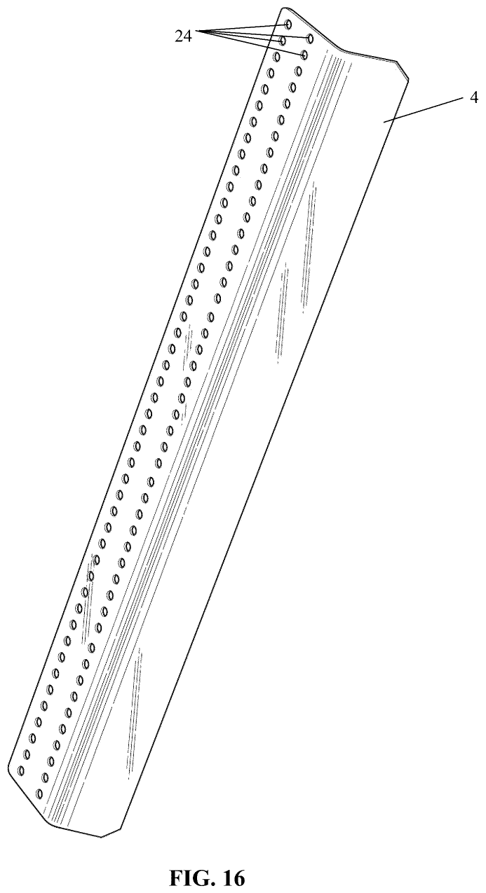

FIG. 15 shows yet another variant of the second preferred embodiment 4 with two rows of six holes 24 to accommodate some display shelves 8 with a different orientation of holes 12. FIG. 16 shows yet another variant of the second preferred embodiment 4 with two rows of a multitude of holes 24.

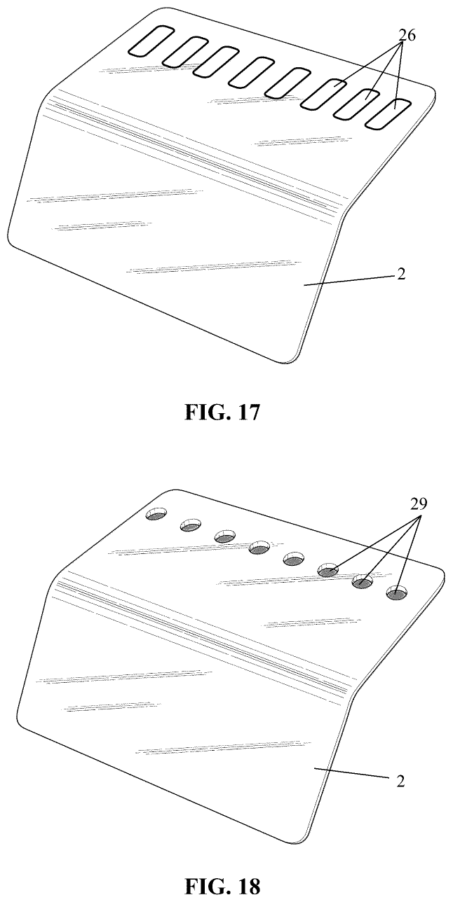

FIG. 17 shows the first preferred embodiment 2 with through-openings being slots 26 that are oriented at 90 degrees to slots 26 seen on FIG. 6. FIG. 18 shows the first preferred embodiment 2 with through-openings being pressure-actuated holes 29, namely holes that are not completely drilled through the entire thickness of mounting portion 14, but drilled to a threshold where an object such as prong in shelf divider 34 can be used to punch or pushed through pressure-actuated hole 29 to convert pressure-actuated hole 29 into hole 24, without damaging protector 2 or 4.

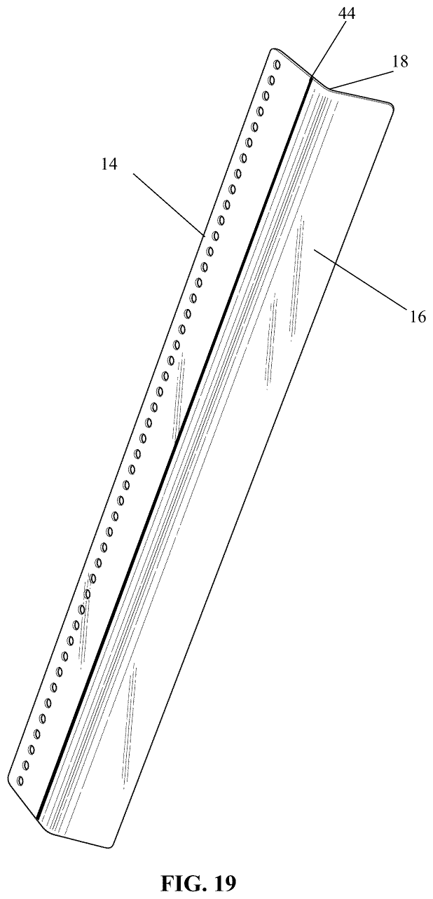

FIG. 19 shows the second preferred embodiment with hinge 44 for easier access to ESL 6. Shielding portion 16 can be folded upwardly along hinge 44 so that store personnel can remove or adjust ESL 6 without having to remove protector 2.

In practice, on a standard store shelf 8, protector 2 or 4 is aligned with ESL 6, and through-openings 24 are aligned with through-openings 12 of forwardmost region of top face of shelf 10. Fasteners 30 or prongs 34 of shelf dividers 32 are inserted into through-openings 24, and subsequently into through-openings 12, thereby locking protector 2 or 4 onto forwardmost region of top face of shelf 10, covering ESL 6. If protector 2 or 4 has to be removed, the installation procedure is reversed.

In non-standard store shelf scenarios, protectors 2 or 4 with variants of through-openings 26 or 28 can be used. As mentioned before, through-openings of mounting portion 14 can be of any configuration, depending on the shape of forwardmost region of top face of shelf 10's through-openings 12.

In some applications, protectors 2 or 4 with pressure-actuated through-openings 29 need to be used. In such cases, a tool such as a prong 34 of shelf divider 32 can be pushed through opening 29 thereby creating a through-opening 24. It should be noted that no drill is necessary to convert pressure-actuated through-opening 29 into through-opening 24, since pressure-actuated through-opening 29 is pre-drilled to the threshold where a simple push of said prong 34 is sufficient to create a full through-opening 24 without structurally damaging protector 2 or 4's mounting portion 14.

1. A shelf edge protector for an electronic shelf label (“ESL”) adapted to protect said ESL from impact disturbance, displacement, or dislodgement, said shelf edge protector being attached to a forwardmost region of a top face of a standard retail shelf, said forwardmost region of said top face of said retail shelf comprising through-openings,
wherein said shelf edge protector comprises
a body made of transparent rigid plastic with
a mounting portion comprising through-openings, and
a shielding portion, connected to said mounting portion via a bend portion, said shielding portion adapted to cover said ESL,
wherein, when said mounting portion is placed on top of said forwardmost region of top face of said shelf, at least 40% of through-openings of said forwardmost region of said top face of said shelf remain unobstructed and accessible through said through-openings of said mounting portion.

2. The shelf edge protector for an ESL according to claim 1, wherein said bend portion is a rigid bend.

3. The shelf edge protector for an ESL according to claim 1, wherein said bend portion comprises a hinge between said bend portion and said row of through-openings of said mounting portion.

4. The shelf edge protector for an ESL according to claim 1, wherein said mounting portion of said shelf edge protector body is attached to said forwardmost region of said top face of said shelf via fasteners so that said shelf edge protector body is firmly and easily attached to said forwardmost region of said top face of said shelf.

5. The shelf edge protector for an ESL according to claim 1, wherein said mounting portion of said body is attached to said forwardmost region of top face of shelf via standard retail shelf dividers, wherein said shelf dividers comprise prongs adapted to be inserted into said through-openings of said retail shelf, and wherein said prongs traverse said through-openings of said shelf edge protector and subsequently said through-openings of said retail shelf, so that said body is firmly and easily attached to said forwardmost region of top face of shelf.

6. The shelf edge protector for an ESL according to claim 1, wherein said mounting portion of said body is attached to said forwardmost region of top face of shelf via a combination of said fasteners and said prongs of said shelf dividers.

7. The shelf edge protector for an ESL according to claim 1, wherein said shielding portion of said shelf edge protector comprises tapered corners to prevent snagging.

8. A shelf edge protector for a plurality of electronic shelf labels (“ESLs”) adapted to protect said ESLs from impact disturbance, displacement, or dislodgement, comprising said shelf edge protector being attached to a forwardmost region of a top face of a standard retail shelf, said forwardmost region of said top face of said retail shelf comprising through-openings,
wherein said shelf edge protector comprises
a body made of transparent rigid plastic with
a mounting portion comprising through-openings, and
a shielding portion, connected to said mounting portion via a bend portion, said shielding portion adapted to cover said ESLs,
wherein, when said mounting portion is placed on top of said forwardmost region of top face of said shelf, at least 40% of through-openings of said forwardmost region of said top face of said shelf remain unobstructed and accessible through said through-openings of said mounting portion.

9. The shelf edge protector for a plurality of ESLs according to claim 8, wherein said bend portion is a rigid bend.

10. The shelf edge protector for a plurality of ESLs according to claim 8, wherein said bend portion comprises a hinge between said bend portion and said row of through-openings of said mounting portion.

11. The shelf edge protector for a plurality of ESLs according to claim 8, wherein said mounting portion of said shelf edge protector body is attached to said forwardmost region of said top face of said shelf via fasteners so that said shelf edge protector body is firmly and easily attached to said forwardmost region of said top face of said shelf.

12. The shelf edge protector for a plurality of ESLs according to claim 8, wherein said mounting portion of said body is attached to said forwardmost region of top face of shelf via standard retail shelf dividers, wherein said shelf dividers comprise prongs adapted to be inserted into said through-openings of said retail shelf, and wherein said prongs traverse said through-openings of said shelf edge protector and subsequently said through-openings of said retail shelf, so that said body is firmly and easily attached to said forwardmost region of top face of shelf.

13. The shelf edge protector for a plurality of ESLs according to claim 8, wherein said mounting portion of said body is attached to said forwardmost region of top face of shelf via a combination of said fasteners and said prongs of said shelf dividers.

14. The shelf edge protector for a plurality of ESLs according to claim 8, wherein said shielding portion of said shelf edge protector comprises tapered corners to prevent snagging.

15. An assembly of standard retail shelf with a shelf edge protector for a plurality of electronic shelf labels (“ESLs”) adapted to protect said ESLs from impact disturbance, displacement, or dislodgement, in operational mode, comprising
a standard retail shelf supporting inventory with a forwardmost region of a top face, comprising through-openings for accommodating prongs of standard retail shelf dividers, and a standard label track on said shelf's front edge with mounted said ESLs,
a shelf edge protector made of a clear, resilient, transparent material, with a mounting portion immobilized onto said forwardmost region of a top face, said protector connected with a bend portion to a shielding portion adapted to shield said ESLs,
wherein said mounting portion comprises through-openings aligning with at least 40% of with said through-openings of said forwardmost region of a top face.

16. The assembly of standard retail shelf with a shelf edge protector for a plurality of ESLs according to claim 15, wherein said mounting portion is immobilized with fasteners.

17. The assembly of standard retail shelf with a shelf edge protector for a plurality of ESLs according to claim 15, wherein said mounting portion is immobilized with said prongs of said shelf dividers.

18. The assembly of standard retail shelf with a shelf edge protector for a plurality of ESLs according to claim 15, wherein said mounting portion is immobilized with a combination of said fasteners and said prongs of said shelf dividers.

19. The assembly of standard retail shelf with a shelf edge protector for a plurality of ESLs according to claim 15, wherein said bend portion is a rigid bend.

20. The assembly of standard retail shelf with a shelf edge protector for a plurality of ESLs according to claim 15, wherein said bend portion comprises a hinge between said bend portion and said row of through-openings of said mounting portion.
